(19) United States
(12) Patent Application Publication
(10) Pub. No.: US 2025/0296572 A1
(43) Pub. Date: Sep. 25, 2025

(54) Method for Processing Sensor Data in a Motor Vehicle

(71) Applicant: Robert Bosch GmbH, Stuttgart (DE)

(72) Inventor: Marcus Wagner, Schwaigern (DE)

(21) Appl. No.: 19/080,877

(22) Filed: Mar. 16, 2025

(30) Foreign Application Priority Data
Mar. 21, 2024 (DE) 10 2024 202 700.6

(51) Int. Cl. B60W 40/02; G06V 20/58

(52) U.S. Cl. CPC B60W 40/02; G06V 20/58; B60W 2420/403; B60W 2420/408

(57) ABSTRACT

A method for processing sensor data in a motor vehicle includes (a) acquiring initial data with a first sensor of a first sensor type, (b) acquiring second data with a second sensor of a second sensor type, (c) extrapolating the first data acquired in accordance with step (a) and/or the second data acquired in accordance with step (b) to produce extrapolated data that allows the first data to be compared with the second data, and (d) performing joint processing of the first data and/or the second data with extrapolated data.

This application claims priority under 35 U.S.C. § 119 to application no. DE 10 2024 202700.6, filed on Mar. 21, 2024 in Germany, the disclosure of which is incorporated herein by reference in its entirety.

The aim here is to describe a method for processing sensor data in a motor vehicle. The method is particularly useful for utilizing environmental data, e.g. data obtained using LIDAR or RADAR sensors or cameras, with the aim of improving positioning using GNSS sensors. The method also serves to validate sensor data from different sensor types with each other and against each other.

### BACKGROUND

In existing applications, GNSS sensors, lidar sensors, radar sensors and/or cameras are usually used independently of each other, with each sensor system validating the quality of its own sensor data.

On this basis, a new approach is to be described for processing sensor data from different sensors, where the different sensors are different sensor types.

### SUMMARY

This object is achieved with the disclosure according to the features set forth below. Further advantageous configurations are specified in the description of the figures. It should be noted that the skilled person can combine the individual features together in a technologically sensible manner and thus arrive at further configurations of the disclosure.

A method for processing sensor data in a motor vehicle is described here, comprising at least the following steps:
a) acquiring initial data with an initial sensor of an initial sensor type;
b) acquiring second data with a second sensor of a second sensor type;
c) extrapolating the first data acquired in accordance with step (a) and/or the second data acquired in accordance with step (b) to produce extrapolated data that allows the first data to be compared with the second data; and
d) performing joint processing of the first data and/or the second data with extrapolated data.

The first sensor and the first sensor type, and the second sensor and the second sensor type, are preferably environment sensors with which the environment of the motor vehicle can be monitored. The first sensor and the second sensor are of different types and preferably even use different physical measuring principles. In design variants, it is also possible that the first sensor type and the second sensor type each use the same physical measuring principle, but are set up for different sensor properties. One example of a different sensor configuration is the adjustment of the sensor to a specific monitoring area in the vicinity of the vehicle. In particular, this may, for example, be a focusing of the respective sensor on a specific monitoring area at a specific distance in front of and/or behind the motor vehicle.

The terms acquiring “first data” in step a) and acquiring “second data” in step b) are used here in the sense that the data is acquired by a sensor module. This also means that data already generated by sensors is acquired by a control unit that executes the described method.

The extrapolation step in step c) describes a modification of the first data and/or the second data with which the comparability of the data is achieved. This creates the basis for the joint data processing in step d). Possible reasons for combining the first and/or second data sets with the extrapolated data sets could be diverse. In the first embodiments of the method described, the joint data processing according to step d) includes, in particular, the checking or validation of the various data from the various data sources (first sensor and second sensor) with each other. In a second embodiment of the method described, the joint data processing according to step d) also includes obtaining additional information, which is particularly characterized by a fusion and/or a mutual supplementation of the first data or the second data with the extrapolated data.

The method described here is in particular described for two different sensors (first and second sensor). However, the method can also be used for more than two sensors, which may also be more than two different sensor types (e.g. at least three sensors with at least three different sensor types).

It is particularly advantageous if the first sensor used in step (a) and the second sensor used in step (b) are each one of the types of sensors included in the following list:
LIDAR;
RADAR;
front camera;
infrared camera;
ultrasonic sensor; or
interior camera.

The sensor types mentioned are environment sensors that work according to different physical measuring principles. The extrapolation in step d) makes the data from sensors of different types comparable and processable together.

Furthermore, it is advantageous if the extrapolation in step c) comprises at least one of the following substeps:
i. ascertaining at least one scaling factor for scaling the second data and the first data in relation to each other;
ii. ascertaining a displacement factor that describes the displacement of the second data and the first data in relation to each other;
iii. applying at least one scaling factor and/or at least one displacement factor to the first data and/or the second data to create extrapolated data.

For example, scaling factors and displacement factors can be ascertained by assigning certain structures that were recognized in the first data and in the second data to each other and then ascertaining scaling factors and/or displacement factors based on this assignment. If, for example, a structure A and a structure B in the first data from the first sensor have a first distance and in the second data from the second sensor have a second distance, then a scaling factor can be determined, for example, using the quotient of the distances. These principles can also be used to determine displacement factors, whereby further reference points (structures) may be necessary to ascertain both displacement factors and scaling factors in different spatial directions.

The method is particularly useful when the vehicle is driven in an urban environment with buildings on the sides of the road. In such an environment, there are many structural features to the right and left of the road that can be recognized in the first data and the second data and assigned to each other.

It must be taken into account that areas around a motor vehicle that are monitored by different sensors of different sensor types do not have to be identical at all times. For example, a first sensor of a first sensor type may be used to monitor an area located at a first distance in front of the motor vehicle. In contrast to this, a second sensor of a second sensor type is used, for example, to monitor an area located at a second distance in front of the motor vehicle, this second distance being shorter than the first distance. In one example, the second distance is 10 meters smaller than the first distance. The second sensor then detects structures that have already been detected by the first sensor at an earlier time. The earlier time at which the first sensor detects certain structures then exists, for example, for a time interval before a later time at which the second sensor detected the same structures. In this case, this time interval corresponds to the time taken by the vehicle to travel the stretch that makes the difference between the first distance and the second distance. In this case, it would be 10 meters. If the vehicle is moving at a speed of 5 meters per second, for example, the time interval would be 2 seconds. These relationships are taken into account in particular by displacement factors and scaling factors in order to extrapolate the extrapolated data according to step c).

It is also advantageous if the extrapolation in step c) is carried out with the aid of map data.

The use of map data is often helpful in order to assign certain structures to each other in both the sensor data and the map data.

The map data used in the method is, in particular, high-resolution map data that very precisely describes structural features in the vicinity of roadways (e.g. buildings, etc.). Using high-resolution maps, the method described in step d) is used to ascertain which of the two sensors (first sensor or second sensor) is still working correctly if the position information provided is contradictory. Furthermore, the other systems can also be used to recognize which system is working correctly. However, this normally requires overlapping evaluation areas of the first sensor and the second sensor, which simultaneously monitor a certain area in the vicinity of the vehicle. The method described here, and in particular the extrapolation step according to step c), makes it possible to assign data from the sensors independently of the map data, so that the map data can be used like a third system. According to step c), a separate check of the first data from the first sensor and the second data from the second sensor is carried out on the basis of the card data. This makes it possible to determine whether the first data from the first sensor and the second data from the second sensor match the map data. The extrapolation step according to step c) can also be used to compare the first data and second data acquired according to steps a) and b) with each other and independently of the map data, and to check their plausibility.

As already mentioned above, the first sensor and the second sensor are preferably so-called environment sensors, with which the environment of a motor vehicle can be monitored. Data acquired by such sensors is regularly environmental data that contains information regarding the environment of the motor vehicle. Environment data are regularly processed in conjunction with map data in motor vehicles in order to localize the vehicle within the map data. Structures recognized in the data from surrounding sensors are assigned to structures contained in the map data. The environment data also includes distances and directions of the detected structures. The distances and directions can be used to locate the vehicle in the map data. A common goal of processing data from environment sensors is therefore to regularly ascertain the position of the motor vehicle (EGO positions) and, if necessary, the speed of the motor vehicle (EGO speeds).

It is further advantageous if the extrapolation in step c) involves a temporal extrapolation that takes into account a temporal displacement in the occurrence of certain structures in the first data and the second data.

It is also advantageous if the extrapolation in step c) involves spatial extrapolation, in which a spatial displacement in the occurrence of certain structures in the first data and the second data is taken into account.

The temporal extrapolation and the spatial extrapolation are regularly linked to one another by the movement of the motor vehicle, which is preferably described with motion equations (also called dynamics equations).

The processing of environmental data regularly includes the recognition of so-called fixation points. These are particularly characteristic points that can be identified in the map data. Due to the differences between the various sensor types, such fixed points are regularly detected at different times with different sensor types. The example was described above in which a first sensor of a first sensor type detects a certain structural feature or a certain structure at a first distance in front of the motor vehicle, while a second sensor of a second sensor type detects the same structural feature or the same structure at a second distance. This means that the time of detection or acquiring varies depending on the speed of the vehicle.

If the dynamic equations describing the movement of the vehicle are used, however, such different times of detection or acquiring of structures with different sensors from different sensor types can be calculated. In the simplest case (a uniform motion of the vehicle in a straight line in a single direction), the dynamic equations describe only the speed of the vehicle. In realistic driving situations, in which motor vehicles regularly brake, accelerate and/or corner, such dynamic equations can also include movements and rotation rates in all spatial directions, including the corresponding accelerations. With the help of such dynamic equations, sensor data from a first sensor of a first sensor type and sensor data from a second sensor of a second sensor type can be extrapolated together. This is possible with the described method, especially if a first measuring range of the first sensor and a second measuring range of the second sensor do not overlap, so that structures are never detected simultaneously with the first sensor and the second sensor.

Furthermore, it is advantageous if structures recognized along a stretch travelled by the motor vehicle are assigned to a waypoint on the stretch in the first data and/or second data, and structures recognized in both the first data and the second data are assigned to one another in step c).

It is further advantageous if the data processing in step d) comprises checking the first data and/or the second data for errors.

The method is used particularly for detecting errors in initial data and/or second data when additional data (e.g. third data from a third sensor of a third sensor type) is also processed.

It is also advantageous if the data processing in step d) includes a recognition of properties of structures in the vicinity of the motor vehicle, which are recognized by different sensor properties of the first sensor type and the second sensor type.

It is also advantageous if the data processing in step d) includes ascertaining of the fields of view for GNSS satellite signals.

The method described can also be used to ascertain a field of view in which GNSS satellite signals are visible using various sensors of different sensor types.

In this context, a field of view refers to an area in which there are unobstructed lines of sight from the vehicle to GNSS satellites. The unobstructed field of view from the motor vehicle is described by the horizon. The unobstructed field of view is above the horizon. GNSS satellites for which there is an unobstructed line of sight from the GNSS satellite to the vehicle are within the unobstructed field of view. GNSS satellites that are behind the horizon from the perspective of the vehicle are outside the unobstructed field of view. Particularly in urban areas, the unobstructed field of view is regularly limited by structures (e.g. houses) to the side of the road. The shape and design of such structures cannot be clearly recognized by conventional environment sensors, especially when the environment sensors are aligned to the front or rear. With forward-looking environment sensors, only the front of structures can be regularly detected. With rear-facing environment sensors, only the rear of structures can be detected on a regular basis. The method described makes it possible to combine data from sensors that are aligned differently. This means that the shape of structures in the vehicle's surroundings can be fully recognized.

The described method is also used to verify the field of view detected by the environment sensors by checking which satellites are actually visible, so that an unobstructed line of sight exists to these satellites. If a satellite is visible that should not be visible according to the field of view detected by the environment sensors, either the environment detection with the environment sensor is faulty or the detection of the GNSS satellite signals is faulty, because, for example, a GNSS signal can still be acquired by signal reflections, but is unsuitable for evaluation and positioning.

In order to recognize whether the error lies in the environmental data or in the GNSS signals, it is preferable to also consider map data. If the recognized structures in the map data are so comprehensible, the error lies in the GNSS signals. If the structures cannot be reconstructed from the map data, the error lies with the environment sensors or their data.

A data processing apparatus for a motor vehicle is also to be described here, comprising a processor that is configured to execute the described method.

Furthermore, a computer program product is to be described, comprising instructions that, when the computer program product is executed by a computer, cause the computer to execute the described method.

A computer-readable storage medium is to be described, comprising instructions that, when executed by a computer, cause the computer to execute the method described.

### BRIEF DESCRIPTION OF THE DRAWINGS

The technical environment of the disclosure is explained in more detail below on the basis of the figures. The figures show preferred exemplary embodiments to which the disclosure is not limited. It should in particular be noted that the figures and in particular the size relationships shown in the figures are merely schematic. The figures show:

FIG. 1: a vehicle with various types of sensors;

FIG. 2: a situation on a stretch as seen from above, compared to a situation in which the vehicle has moved along the stretch;

FIG. 3a: a situation on the stretch for a motor vehicle in a perspective view;

FIG. 3b: the situation shown in FIG. 3a in cross-section;

FIG. 4a: a field of view of the GNSS satellite signals in the situation according to FIG. 3a;

FIG. 4b: the field of view according to FIG. 4a in a cross-sectional view; and

FIG. 5: a flow chart of the described method.

### DETAILED DESCRIPTION

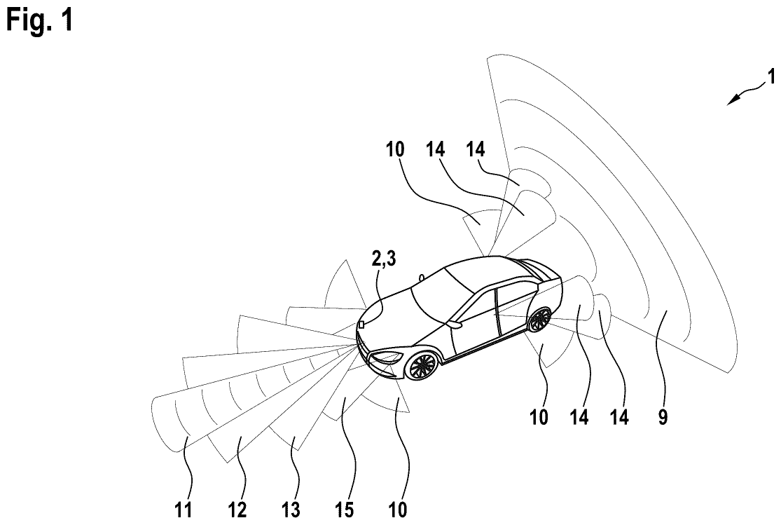

FIG. 1 shows a motor vehicle 1 with many sensors. First sensors 2 and second sensors 3, which may be of different sensor types. The various sensor types have widely differing detection ranges. The individual sensor types are shown in FIG. 1 here, each based on their detection range. Radar sensors 9, side cameras 10, long-range radar sensors 11 for the front area, lidar sensors 12, front cameras 13, ultrasonic sensors 14 and infrared cameras 15 are shown as examples. The representation of sensor types according to FIG. 1 is not exhaustive. The method can be applied to other sensor types.

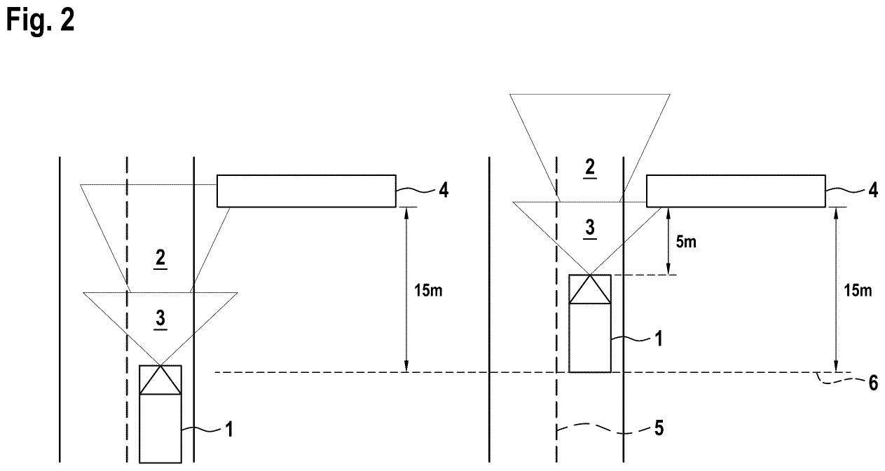

FIG. 2: a situation on the stretch in front of a motor vehicle, as seen from above, compared to a situation in which the motor vehicle has moved further along the stretch 5; note the structure 4 to the side of the stretch 5 in both situations. The motor vehicle 1 has a first sensor 2 with a first monitoring area and a second sensor 3 with a second monitoring area. The first sensor 2, for example, is set up to detect structures located at a distance of 15 meters in front of the vehicle 1. The second sensor 3, for example, is designed to detect structures located at a distance of 5 meters in front of the vehicle 1. Structure 4, shown here as an example, is detected by the first sensor 2 in the situation shown on the left. In the situation shown on the right, the structure 4 is then detected by the second sensor 3. The situation shown on the left and the situation shown on the right are linked by the dynamics with which the motor vehicle is moved. With the extrapolation according to step c), the first data from the first sensor 2 and the second data from the second sensor 3 are linked according to the dynamics and extrapolated in such a way that an assignment/comparability of the data to each other exists. Based on the dynamics of the movement of motor vehicle 1, the structure can be assigned to waypoints 6 on the route of motor vehicle 1.

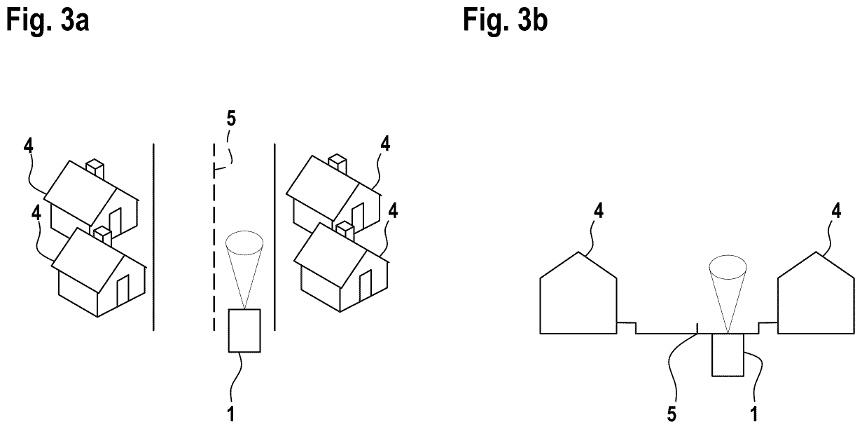

FIGS. 3a and 3b show a situation along a stretch 5 of a motor vehicle with structures 4 in a three-dimensional perspective (FIG. 3a) and in a cross-sectional perspective (FIG. 3b). Sensors facing forward on a motor vehicle can only detect one side of the structures 4 in the vicinity of the stretch 5. Three-dimensionality of the vicinity of a motor vehicle cannot be fully detected with forward-facing (or rearward-facing) environment sensors. By extrapolating the data from different sensors together, as proposed here, and by carrying out data processing, such a three-dimensionality of the surrounding situation can be detected much better with several sensors together.

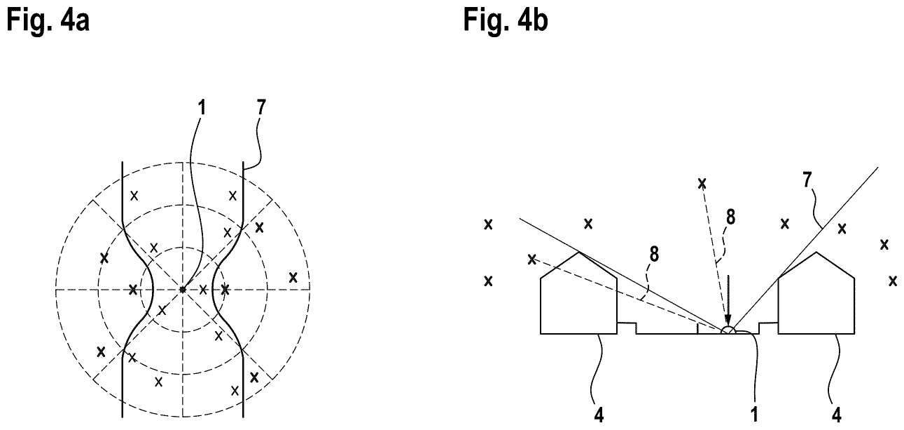

FIGS. 4a and 4b show an unobstructed field of view 7 for GNSS satellite signals 8 in the vicinity of a motor vehicle 1, once from a top view (FIG. 4a) and once from a cross-section view (FIG. 4b). The situation shown in FIGS. 4a and 4b is modeled on the situation shown in FIGS. 3a and 3b. The structures 4 (houses) to the right and left of the roadway lead to a narrowing of the field of view 7, which can be seen in FIG. 4a. Along the stretch, the field of view 7 is not restricted or is restricted to a lesser extent. The method described can be used to process data from different sensors in order to ascertain such a field of view 7.

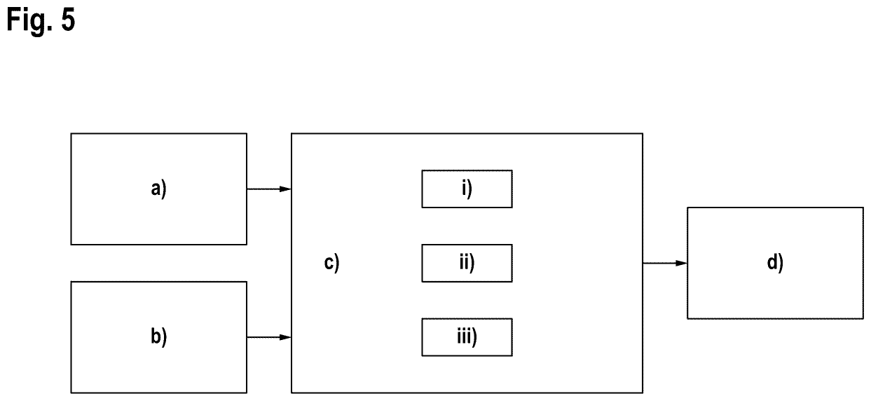

FIG. 5 shows a flow diagram of the described method. The steps a) and b) according to which sensor data is acquired can be recognized, as well as the subsequent method step c), which preferably includes at least one of the three sub-steps i), ii), and iii). In step d), the data is processed jointly.

What is claimed is:

1. A method for processing sensor data in a motor vehicle, comprising:
(a) acquiring initial data with a first sensor of a first sensor type;
(b) acquiring second data with a second sensor of a second sensor type;
(c) extrapolating the first data acquired in accordance with step (a) and/or the second data acquired in accordance with step (b) to produce extrapolated data that allows the first data to be compared with the second data; and
(d) performing joint processing of the first data and/or the second data with extrapolated data.

2. The method according to claim 1, wherein the first sensor used in step (a) and the second sensor used in step (b) are each one of the types of sensors included in the following list:
LIDAR;
RADAR;
front camera;
infrared camera;
ultrasonic sensor; or
interior camera.

3. The method according to claim 1, wherein the extrapolating in step (c) comprises at least one of the following substeps:
(i) ascertaining at least one scaling factor for scaling the second data and the first data in relation to each other;
(ii) ascertaining a displacement factor that describes the displacement of the second data and the first data in relation to each other; and
(iii) applying at least one scaling factor and/or at least one displacement factor to the first data and/or the second data to create extrapolated data.

4. The method according to claim 1, wherein the extrapolation in step (c) is performed with the aid of map data.

5. The method according to claim 1, wherein the extrapolation in step (c) comprises a temporal extrapolation that takes into account a temporal displacement in the occurrence of certain structures in the first data and the second data.

6. The method according to claim 1, wherein the extrapolation in step (c) comprises a spatial extrapolation in which a spatial displacement of the occurrence of certain structures in the first data and the second data is taken into account.

7. The method according to claim 1, wherein structures recognized in the first data and/or second data along a stretch covered by the motor vehicle are assigned to a waypoint on the stretch, and structures recognized in both the first data and the second data are assigned to one another in step (c).

8. The method according to claim 1, wherein the data processing in step (d) comprises checking the first data and/or the second data for errors.

9. The method according to claim 1, wherein the data processing in step (d) comprises a recognition of properties of structures in the vicinity of the motor vehicle which are recognized by different sensor properties of the first sensor type and the second sensor type.

10. The method according to claim 1, wherein the data processing in step (d) comprises ascertaining the fields of view for GNSS satellite signals.

11. A data processing device for a motor vehicle, comprising a processor configured to execute the method according to claim 1.

12. A computer program product comprising instructions which, when the computer program product is executed by a computer, cause the computer to execute the method according to claim 1.

13. A computer-readable storage medium comprising instructions which, when executed by a computer, cause the computer to execute the method according to claim 1.
